(19) United States
(12) Patent Application Publication
(10) Pub. No.: US 2025/0060513 A1
(43) Pub. Date: Feb. 20, 2025

(54) ANTIGLARE ANTIREFLECTION PLATE

(71) Applicant: FUKUVI CHEMICAL INDUSTRY CO., LTD., Fukui (JP)

(72) Inventors: Takuya ITO, Fukui (JP); Fumiya Yasui, Fukui (JP); Takashi Michishita, Fukui (JP)

(73) Assignee: FUKUVI CHEMICAL INDUSTRY CO., LTD., Fukui (JP)

(21) Appl. No.: 18/800,544

(22) Filed: Aug. 12, 2024

(30) Foreign Application Priority Data
Aug. 14, 2023 (JP) 2023-131797

(51) Int. Cl. G02B 1/11; G02B 1/14

(52) U.S. Cl. CPC G02B 1/11; G02B 1/14

(57) ABSTRACT

An antiglare antireflection plate having excellent antireflection and antiglare properties is provided as following:
the said plate is an antiglare antireflection plate including a hard coat layer, an antiglare layer, and an antireflection coat, in which the hard coat layer, the antiglare layer, and the antireflection coating are laminated in this order on a transparent resin base material, the antiglare layer is made of a cured product of a composition containing 0.1 to 15.0 parts by mass of inorganic particles having an average particle diameter (D50) of 500 nm to 700 nm relative to 100 parts by mass of a polymerizable acrylate compound, and line roughness characteristics defined in JIS B 0601 on a surface of the antiglare antireflection plate are as follows. An arithmetic average roughness (Ra) is 0.03 μm or more and 0.20 μm or less, an average length (RSm) is 10 μm or more and 70 μm or less, a skewness (Rsk) is −0.05 or more and 1.50 or less, a kurtosis (Rku) is 2.0 or more and 5.0 or less, and a maximum peak height (Rp)/maximum valley depth (Rv) is 1.0 or more and 3.0 or less. A haze value of the antiglare antireflection plate is 0.5% to 20.0%.

### BACKGROUND OF THE INVENTION

### 1. Field of the Invention

The present invention relates to an antiglare antireflection plate having excellent antireflection and antiglare properties.

### 2. Description of the Related Art

In the related art, in various display devices such as personal computers, mobile phones, LCD monitors, automated teller machines, automobile meter panels, and navigation panels, preventing reflections and glare under natural and artificial light to maintain visibility has been considered as an issue, and various countermeasures have been implemented to address this.

An antireflection film (plate) has been developed as a countermeasure, and the purpose is achieved by attaching the film to the surface of a display device. The antireflection film includes an antireflection coat constituted by an interference layer on the surface part thereof, which reduces the reflectance on the surface, prevents reflected glare and the like, and secures good visibility.

Another optical characteristic that affects visibility is glaring caused by scattered reflection and diffusion of light on a surface. In order to suppress glaring (hereinafter also referred to as antiglare), technology for imparting irregularities to the surface for the purpose of dispersing and diffusing light has been developed.

In the related art, as a method of imparting irregularities to a surface, a method such as embossing using a hot press with a mold subjected to unevenness processing, or irregularity formation using an embossing roller has been adopted (see, JP 2018-77279 A and JP 2004-333936 A). However, such physical forming methods have the following problems:
Antiglare properties vary because embossing cannot be performed uniformly
Antiglare properties vary depending on the type of substrate
An embossing range is limited due to the size of an embossing machine and the size of a base material
Antiglare properties differ between a central portion and an edge of a base material, and thus edges have to be cut off, reducing an effective usable area and reducing productivity
Increased steps and batch processing result in poor production efficiency and increased costs

### SUMMARY OF THE INVENTION

As a result of intensive research to solve the above-described problems, the inventors of the present application have found that it is possible to control line roughness characteristics of a surface and achieve antiglare properties by providing an antiglare layer on a surface part of an antireflection plate and manufacturing the antiglare layer by using a coating method in which a curable composition containing particles of a specific particle diameter is applied on the layer so as to be cured, and have completed the present invention.

That is, according to the present invention, there is provided an antiglare and antireflection plate including a hard coat layer, an antiglare layer, and an antireflection coat, which are laminated in this order on a transparent resin base material, the antiglare layer is made of a cured product of a composition containing 0.1 to 15.0 parts by mass of inorganic particles having an average particle diameter (D50) of 500 nm to 700 nm relative to 100 parts by mass of a polymerizable acrylate compound, and line roughness characteristics defined in JIS B 0601 on a surface of the antiglare antireflection plate are as follows: an arithmetic average roughness (Ra) of 0.03 μm or more and 0.20 μm or less, an average length (RSm) of 10 μm or more and 70 μm or less, a skewness (Rsk) of −0.05 or more and 1.50 or less, a kurtosis (Rku) of 2.0 or more and 5.0 or less, and a maximum peak height (Rp)/maximum valley depth (Rv) of 1.0 or more and 3.0 or less.

In the invention of the antiglare antireflection plate, it is preferable that
1) the antireflection coat is constituted by a low refractive index layer having a refractive index of 1.20 to 1.45 and a layer thickness of 50 nm to 200 nm, the inorganic particles are silica particles, and the antiglare antireflection plate has a haze value of 0.5% to 20.0%,
2) the antireflection coat includes a medium refractive index layer having a refractive index of 1.50 to 1.75 and a layer thickness of 50 nm to 200 nm, a high refractive index layer having a refractive index of 1.60 to 2.00 and a layer thickness of 50 nm to 200 nm, and a low refractive index layer having a refractive index of 1.20 to 1.45 and a layer thickness of 50 nm to 200 nm in this order, the refractive index of the high refractive index layer is higher than the refractive index of the medium refractive index layer, the inorganic particles are silica particles, and the antiglare antireflection plate has a haze value of 0.5% to 15.0%,
3) the antiglare layer is made of a cured product having a composition containing 0.1 to 15.0 parts by mass of inorganic particles, 0.1 to 1.0 parts by mass of a metal chelate compound, and 0.0 to 45.0 parts by mass of silica fine particles, relative to 100 parts by mass of a polymerizable acrylate compound (total 100% by mass) containing 70% to 90% by mass of a hexafunctional urethane (meth)acrylate and 30% to 10% by mass of a bi- to tetrafunctional (meth)acrylate compound,
4) an average layer thickness of the antiglare layer is 100 nm to 500 nm, and
5) a protective layer and an anti-fouling layer are further laminated in this order above the antireflection coating (on a viewing side).

An antiglare antireflection plate of the present invention has excellent antiglare properties in addition to high antireflection properties. Thus, the antiglare antireflection plate is effectively used not only in general display devices, but also in panels of devices which are required for high visibility, such as automobile meter panels and touch panels of car navigation systems. Further, the antiglare antireflection plate can also be suitably used in display devices used outdoors, such as smartphones and tablets.

Since the above antiglare antireflection plate can be manufactured by a coating method, it has remarkable industrial value, such as suppressing variations in antiglare properties, allowing manufacture of any antiglare antireflection plate regardless of the size of a base material, and being advantageous in terms of productivity and cost.

### BRIEF DESCRIPTION OF THE DRAWINGS

FIG. 1 is a laser photograph of the surface of an antiglare antireflection plate obtained in Example 1;

FIG. 2 is a diagram showing a measured cross-sectional curve and a roughness curve of the antiglare antireflection plate obtained in Example 1;

FIG. 3 is a laser photograph of the surface of an antiglare antireflection plate obtained in Comparative Example 1; and

FIG. 4 is a diagram showing a measured cross-sectional curve and a roughness curve of the antiglare antireflection plate obtained in Comparative Example 1.

### DESCRIPTION OF THE PREFERRED EMBODIMENTS

### Antiglare Antireflection Plate

An antiglare antireflection plate of the present invention has a basic structure in which a transparent resin base material, a hard coat layer, an antiglare layer, and an antireflection coat are laminated in this order. The antiglare antireflection plate of the present invention is not limited to the structure as long as it has the above-mentioned basic structure. For example, it is suitable to provide a protective layer that imparts abrasion resistance on the antireflection coat (on a viewing side) and further provide an anti-fouling layer on the protective layer to prevent contamination by oily components or chemical solutions. In addition, an adhesive layer made of an acrylic, rubber, or silicone adhesive can be provided on the back side of the antiglare antireflection plate. Furthermore, a hard coat layer, an antiglare layer, and an antireflection coat may be laminated on both the front and back surfaces of a transparent resin base material.

The antiglare antireflection plate has the following surface characteristics (line roughness characteristics defined in JIS B 0601) and has excellent antiglare properties.
Arithmetic average roughness (Ra) of 0.03 μm or more and 0.20 μm or less
Average length (RSm) of 10 μm or more and 70 μm or less
Skewness (Rsk) of −0.05 or more and 1.50 or less
Kurtosis (Rku) of 2.0 or more and 5.0 or less
Maximum peak height (Rp)/maximum valley depth (Rv) of 1.0 or more and 3.0 or less

### Arithmetic Average Roughness (Ra)

The arithmetic average roughness (Ra) represents an average of R(x)<absolute value> in a reference length. The arithmetic average roughness (Ra) is 0.03 μm or more and 0.20 μm or less.

### Average Length (RSm)

The average length (RSm) represents an average length of a contour curve element in a reference length, and Xsi is a length corresponding to one contour line element. In this case, peaks (valleys) that constitute a contour element have minimum height and length regulations, and any peak (valley) whose height (depth) is 10% or less of the maximum height or whose length is 1% or less of the length of a calculation section is regarded as noise and recognized as a part of valleys (peaks) that continues before and after. The average length (RSm) is 10 μm or more and 70 μm or less, and it can be seen that not only irregularities caused by contained inorganic particles but also irregularities of a curable polymerizable acrylate compound contribute.

### Skewness (Rsk)

The skewness (Rsk) represents a cube mean of R(x) in a reference length, which is made dimensionless by the cube of a root mean square height (Rq), and is a parameter closely related to tribology (friction).

The skewness represents the degree of distortion and shows symmetry of a distribution of peaks and valleys. In the case of a normal distribution, the skewness is 0 (zero), and in the case of a worn surface, the skewness is negative, indicating that the distribution is biased upward. The skewness (Rsk) is-0.05 or more and 1.50 or less, indicating that there are many relatively fine peaks.

### Kurtosis (Rku)

The kurtosis (Rku) represents a fourth-square mean of R(x) in a reference length, made dimensionless by the fourth power of a root mean square height (Rq), and is a parameter closely related to tribology (friction).

The kurtosis represents the degree of sharpness and is 3 in the case of a normal distribution. When the kurtosis (Rku) is 2.0 or more and 5.0 or less, this indicates that the degree of sharpness of the surface is not very high, but the overall surface is rough.

### Maximum Peak Height (Rp)/Maximum Valley Depth (Rv)

This indicates how many times the height of a peak is greater than the depth of a valley. The larger the value, the higher the peak and the shallower the valley. When the maximum peak height (Rp)/maximum valley depth (Rv) is 1.0 or more and 3.0 or less, this indicates that the height of the peak is relatively greater than the depth of the valley.

### Haze Value

The antiglare antireflection plate of the present invention satisfies the above-described surface characteristics, resulting in a haze value of 0.5% to 20.0% and excellent antiglare properties. The haze value is affected by a layer structure of the antireflection coating, but glaring is suppressed because the haze value falls within the range.

The haze value is a physical property value that serves as a measure of antiglare properties. The higher the haze value, the higher the antiglare properties, but when the haze value exceeds 20.0%, the transparency of the antiglare antireflection plate decreases, which is undesirable. When the haze value is less than 0.5%, the transparency is high, but glaring is increased and visibility is reduced. A suitable haze value is 0.5% to 15.0%, and a more suitable haze value is 0.8% to 13.5%.

### Transparent Resin Base Material

As the resin base material, a transmissive resin base material is suitably used according to the purpose of use. For example, a base material made of a thermoplastic resin with a total light transmittance of 85% or more at wavelengths of 750 nm to 400 nm is preferable. The thickness of the base material is arbitrarily selected according to the purpose of use, but is usually 0.5 mm to 3 mm.

Examples of such a transmissive thermoplastic resin may include an acrylic resin represented by polymethyl methacrylate, a polycarbonate resin, a polyethylene terephthalate resin, a polyallyl diglycol carbonate resin, a polystyrene resin, and the like.

The base material may be a laminated resin base material in which two of the above-mentioned resins are laminated, but it is preferable that a surface having the hard coat layer formed thereon be formed from an acrylic resin, a polycarbonate resin, or a polyethylene terephthalate resin. Preferably, a laminated resin base material made of a polycarbonate resin and an acrylic resin is used.

In addition, such a transparent resin base material may be colored with an oil-soluble dye or the like as long as its light transmittance is not impaired.

### Hard Coat Layer

The hard coat layer is laminated on the transparent resin base material, and the antiglare layer to be described below is formed on the hard coat layer.

The hard coat layer is a layer that contributes to the strength of the antiglare antireflection plate and adhesion between the transparent resin base material and the antiglare layer. By improving this adhesion, the antiglare antireflection plate of the present invention has excellent abrasion resistance and hardness.

The thickness of a hard coat layer is usually 1 μm to 5 μm. When the thickness is less than 1 μm, the strength and other properties of the hard coat layer will be impaired, and when the thickness exceeds 5 μm, cracks will easily occur. The thickness is preferably 1 μm to 3 μm, and particularly preferably 1 μm to 2 μm.

In order to obtain excellent adhesion between the transparent resin base material and the antiglare layer, and excellent hardness of hard coat layer itself, a hard coat layer made of a cured product of a curable composition containing a polymerizable acrylate compound, which contains 70% to 90% by mass of a hexafunctional or higher functional urethane (meth)acrylate compound, silica fine particles, a silane coupling agent, and a metal chelate compound is suitable.

A typical formulation of a curable composition is 20 to 50 parts by mass of silica fine particles, 5 to 15 parts by mass of a silane coupling agent, and 0.1 to 1.5 parts by mass of a metal chelate compound, relative to 100 parts by mass of a polymerizable acrylate compound (total 100% by mass) consisting of 80% to 90% by mass of a hexafunctional or higher functional urethane (meth)acrylate compound and 20% to 10% by mass of a (meth)acrylate compound.

### Hexafunctional or Higher Functional Urethane (Meth)Acrylate Compound; Hereinafter Also Referred to as Hexafunctional Urethane (Meth)Acrylate

A hexafunctional urethane (meth)acrylate is a polymerizable acrylate compound obtained by addition reaction of a terminal isocyanate compound, which is obtained by reacting a polyol compound with a diisocyanate compound, with a (meth)acrylate compound having a plurality of hydroxyl groups, and can be obtained by reacting these two raw materials in an amount ratio such that the amount of (meth)acryloyl groups is 6 times or more by mole, by using a method known per se. For example, it is possible to obtain a hexafunctional urethane (meth)acrylate with three (meth)acryloyl groups at each end of a molecular chain by reacting pentaerythritol tri (meth)acrylate with isocyanates at both ends (such as trihexadiethylene diisocyanate).

Specific examples of hexafunctional urethane (meth)acrylate may include dipentaerythritol hexa (meth)acrylate, phenyl glycidyl ether (meth)acrylate hexamethylene diisocyanate urethane prepolymer, phenyl glycidyl ether (meth)acrylate isophorone diisocyanate urethane prepolymer, phenyl glycidyl ether (meth)acrylate tolylene diisocyanate urethane prepolymer, glycerin di(meth)acrylate tolylene diisocyanate urethane oligomer, pentaerythritol tri (meth)acrylate hexamethylene diisocyanate urethane oligomer, glycerin di(meth)acrylate isophorone diisocyanate urethane oligomer, pentaerythritol tri (meth)acrylate tolylene diisocyanate urethane oligomer, pentaerythritol tri (meth)acrylate isophorone diisocyanate urethane pre-oligomer, and the like, but these may be used alone or in combination of two or more.

These hexafunctional urethane (meth)acrylates are commercially available as, for example, Art Resin series (Negami Chemical Industrial Co., Ltd.), U/UA Oligo series (Shin-Nakamura Chemical Co., Ltd.), Shiko UV series (Nippon Synthetic Chemical Industry Co., Ltd.), and Urethane Acrylate UA series (Kyoeisha Chemical Co., Ltd.), and are generally available.

When a compounding ratio of hexafunctional urethane (meth)acrylate in the polymerizable acrylate compound is less than 70% by mass, abrasion resistance tends to deteriorate, which is not preferable. When the compounding ratio exceeds 90% by mass, cracks tend to occur easily. It is preferable to use it in combination with other polymerizable acrylate compounds listed below in consideration of the hardness and impact resistance of a cured body, adhesion to an antiglare layer, even coatability, and the like.

Other Polymerizable Acrylate Compounds Other polymerizable acrylate compounds include (meth)acrylate compounds exemplified by monofunctional (meth)acrylate compounds such as methyl (meth)acrylate, ethyl (meth)acrylate, n-butyl (meth)acrylate, lauryl (meth)acrylate, and hydroxyethyl (meth)acrylate; bifunctional (meth)acrylate compounds such as ethylene glycol di(meth)acrylate and triethylene glycol di(meth)acrylate; tri- to tetrafunctional (meth)acrylate compounds such as pentaerythritol tri (meth)acrylate, dipentaerythritol tri (meth)acrylate, dipentaerythritol tetra(meth)acrylate, and trimethylolpropane tri (meth)acrylate.

Further, examples thereof may include bi- to tetrafunctional urethane (meth)acrylate compounds obtained by polyaddition reaction of a diisocyanate compound with a (meth)acrylate compound having a plurality of hydroxyl groups, and in which the number of (meth)acryloyl groups is controlled to be 2 to 4.

These other polymerizable acrylate compounds are commercially available and thus generally available, and may be used alone or in combination of two or more depending on the purpose.

### Silica Fine Particles

The silica fine particles used for the hard coat layer are particles that contribute to an improvement in adhesion and coatability, and there are no particular limitations on their properties. Usually, silica fine particles having a spherical shape, an average particle diameter (D50) of 5 nm to 50 nm, and a refractive index of 1.44 to 1.50 are used. When the average particle diameter (D50) is out of the range, coatability tends to deteriorate. The average particle diameter of the particles used in the present invention refers to a particle diameter (D50) at an integrated value of 50% in a particle size distribution obtained by a laser diffraction/scattering method.

The above-mentioned silica fine particles are non-hollow particles which consist of single particles and whose inside is dense, having not internal cavities, and usually have a density of 1.9 g/cm³ or more. The silica fine particles themselves are well known and commercially available. Commercially available silica fine particles are usually supplied in a state of being dispersed in a solvent, and thus this solvent is inevitably mixed into a solution (coating liquid) of a curable composition used to form the hard coat layer and operates in the same manner as other solvents.

### Silane Coupling Agent

The silane coupling agent itself is hydrolyzed to form a dense siliceous coat. Any known agent can be used without limitation, and specific examples of the agent may include γ-(meth)acryloxypropyltrimethoxysilane, γ-glycidoxypropyltrimethoxysilane, β-(3,4-epoxycyclohexyl)ethyltrimethoxysilane, γ-glycidoxypropylmethyldiethoxysilane, γ-aminopropyltriethoxysilane, γ-aminopropylmethyldimethoxysilane, N-(β-aminoethyl)-γ-aminopropyltrimethoxysilane, γ-anilinopropyltrimethoxysilane, γ-(N-styrylmethyl-β-aminoethylamino) propyltrimethoxysilane hydrochloride, γ-mercaptopropyltrimethoxysilane, and the like.

Depending on the type, the silane coupling agent may be suitably converted into a decomposition product by hydrolysis in advance with a dilute acid or the like for the purpose of improving solubility in water or a solvent, and also contains the hydrolyzate. There are no particular limitations on a method of performing hydrolysis in advance, and a method of performing hydrolysis of a part of the agent using an acid catalyst such as acetic acid is generally used.

### Metal Chelate Compound

The metal chelate compound functions to introduce a cross-linked structure into the hard coat layer to make it denser.

As described above, a large amount of hexafunctional urethane (meth)acrylate is used for the hard coat layer of the present invention, and thus the hard coat layer has excellent flexibility but reduced density. The metal chelate compound is used to compensate for such a reduction in density without impairing flexibility. Furthermore, since such a metal chelate compound is also contained in the antiglare layer, adhesion between the hard coat layer and the antiglare layer is further improved.

The metal chelate compound is a compound in which a chelating agent, which is typically a bidentate ligand, is coordinated to metals such as titanium, zirconium, and aluminum, and any known compound can be used without limitation.

An aluminum chelate compound is preferable, and specific examples thereof include diethoxy mono(acetylacetonate)aluminum, monoethoxy bis(acetylacetonate)aluminum, di-i-propoxy mono(acetylacetonate)aluminum, monoethoxy bis(ethylacetoacetate)aluminum, diethoxy mono(ethylacetoacetate)aluminum, aluminum triacetylacetonate, and the like.

### Formation of Hard Coat Layer

The above-mentioned essential components and any optional components are usually mixed and stirred in any order with an organic solvent to be described below at around room temperature to form a solution of a curable composition (coating liquid). After this solution is applied to the transparent resin base material, the transparent resin base material is dried at 50° C. or higher to remove the solvent, and is then cured by emitting ultraviolet light to form a hard coat layer.

As the optional components, a polymerization initiator for curing the curable composition, a hydrolysis catalyst for promoting condensation curing, an ultraviolet absorber, an organic solvent for dilution to form a coating liquid, and the like are used.

As the polymerization initiator, a known thermal polymerization initiator or photopolymerization initiator is used with a catalytic amount. As the hydrolysis catalyst, an aqueous solution of an acid such as hydrochloric acid, sulfuric acid, nitric acid, or acetic acid is used with a catalytic amount.

From the viewpoint of coatability, organic solvents are usually used such that a total concentration of essential and optional components is 15% to 40% by mass. Suitable organic solvents to be used include alcohol-based solvents such as ethyl alcohol and (iso) propyl alcohol; aromatic solvents such as toluene and xylene; acetate ester-based solvents such as (iso)butyl acetate; and ketone-based solvents such as methyl ethyl ketone and methyl isobutyl ketone. These organic solvents are evaporated and removed when the hard coat layer is formed.

There are no particular limitations on a method of applying the coating liquid onto the transparent resin base material, and methods such as dip coating, roll coating, die coating, flow coating, and spraying can be used, but dip coating is preferable from the viewpoint of appearance quality and layer thickness control.

### Antiglare Layer

The antiglare layer is provided on the hard coat layer. In the present invention, the antiglare layer is formed by a coating method and is characterized by being made of a cured product of a composition containing 0.1 to 15.0 parts by mass of inorganic particles having an average particle diameter (D50) of 500 nm to 700 nm relative to 100 parts by mass of a polymerizable acrylate compound.

The thickness of the antiglare layer is usually 100 nm to 500 nm. When the thickness is less than 100 nm, the inorganic particles tend to protrude excessively. When the antireflection coat is laminated on the antiglare layer, the excessively protruding inorganic particles will enter the antireflection coat and increase a refractive index. As a result, a reflectance increases, and antireflection properties are impaired. When the thickness exceeds 500 nm, the number of inorganic particles buried in a binder component increase, and antiglare properties are not sufficiently exhibited. In addition, the transparency of the antiglare antireflection plate decreases, which is not preferable. The thickness is preferably 150 nm to 450 nm, and particularly preferably 200 nm to 400 nm.

A preferred formulation of the curable composition is 0.1 to 15.0 parts by mass of inorganic particles, 0.1 to 1.0 parts by mass of a metal chelate compound, and 0.0 to 45.0 parts by mass of silica fine particles, relative to 100 parts by mass of a polymerizable acrylate compound (total 100% by mass) consisting of 70% to 90% by mass of a hexafunctional urethane (meth)acrylate and 30% to 10% by mass of a bi- to tetrafunctional (meth)acrylate compound.

The surface characteristics of the formed antiglare layer are followed and maintained even when an antireflection coat, a protective layer, or an anti-fouling layer is provided on the antiglare layer. As a result, the antiglare antireflection plate exhibits the above-mentioned surface characteristics (line roughness characteristics) and exhibits antiglare properties.

### Polymerizable Acrylate Compound

A polymerizable acrylate compound is a general term for acrylate-based polymerizable compounds including the above-mentioned hexafunctional urethane (meth)acrylate and other polymerizable acrylate compounds.

From the viewpoint of adhesion between the hard coat layer and the antireflection layer, the polymerizable acrylate compound in the curable composition for forming the antiglare layer preferably has a mixture composition of 70% to 90% by mass of a hexafunctional urethane (meth)acrylate and 30% to 10% by mass of a bi- to tetrafunctional (meth)acrylate compound.

### Inorganic Particles

In order for the antiglare antireflection plate of the present invention to exhibit the above-mentioned line roughness characteristics, it is necessary to use inorganic particles having an average particle diameter (D50) of 500 nm to 700 nm.

When inorganic particles having an average particle diameter (D50) in the above-mentioned range are used, the antiglare antireflection plate of the present invention exhibits the above-mentioned surface characteristics (line roughness characteristics) due to the size, thereby exhibiting antiglare properties. When the average particle diameter is less than 500 nm, antiglare properties are not exhibited, and when the average particle diameter exceeds 700 nm, white blurring (white turbidity) occurs, causing poor appearance.

The surface characteristics depend on the average particle diameter (D50) of the particles used. Thus, in the case of particles having an average particle diameter (D50) in the above-mentioned range, there are no particular limitations on a chemical composition or characteristics of the particles as long as they do not chemically deteriorate the antiglare layer or the antireflection coat. Specific examples of the particles include inorganic oxide particles such as silica, alumina, zirconia, titania, and zinc oxide; nitride particles such as aluminum nitride and boron nitride; and inorganic salt particles such as magnesium sulfate and calcium carbonate.

The inorganic particles need to be mixed in the range of 0.1 to 15.0 parts by mass relative to 100 parts by mass of a polymerizable acrylate compound. In the case of less than 0.1 parts by mass, the above-mentioned surface characteristics (line roughness characteristics) are not exhibited. In the case of more than 15.0 parts by mass, white blur occurs, which is not preferable.

### Silica Particles

Among inorganic particles, silica particles are particularly suitable in terms of not causing chemical deterioration of the antiglare layer or the antireflection coat and being easily available. Silica particles have the same chemical composition and structure as the silica fine particles used for the hard coat layer described above, but are significantly different in that their average particle diameter (D50) is 500 nm to 700 nm. Silica particles are known per se and are usually commercially available in a state of being dispersed in a solvent. In addition, the silica fine particles described above may be mixed for the purpose of improving coatability.

### Formation of Antiglare Layer

The above-mentioned essential components and any optional components are usually mixed and stirred in any order with an organic solvent to be described below at around room temperature to form a solution of a curable composition (coating liquid). After this solution is applied onto the hard coat layer, the hard coat layer is dried at 50° C. or higher to remove the solvent, and is then cured by emitting ultraviolet light to form an antiglare layer.

As the optional components, a metal chelate compound, a polymerization initiator, silica particles, and the like are used. These optional components, an organic solvent for dilution, a coating method, and the like are the same as those for the hard coat layer.

### Anti-Reflection Film

The antiglare antireflection plate of the present invention is formed by laminating an antireflection coat on the antiglare layer. The antireflection coat includes a low refractive index layer with a refractive index of 1.20 to 1.45 as an essential layer. When the refractive index of the low refractive index layer is out of this range, it does not function as an antireflection coat.

In order to achieve a high level of antireflection properties, it is preferable that the antireflection coat be configured to have a two-layer structure including a low refractive index layer having a refractive index of 1.20 to 1.45 and a high refractive index layer having a refractive index of 1.60 to 2.00. It is further preferable that the antireflection coat be configured to have a three-layer structure in which a medium refractive index layer having a refractive index of 1.50 to 1.75 and lower than the high refractive index layer is provided below (on the antiglare layer side) the high refractive index layer. When the antireflection coat is constituted by a plurality of refractive index layers, the low refractive index layer is located on the outermost layer (on a viewing side) of the antireflection coat.

### Low Refractive Index Layer

The low refractive index layer is typically formed by curing a curable composition containing a silane coupling agent, a metal chelate compound, and hollow silica fine particles.

The hollow silica fine particles are mixed in an amount of 30 to 200 parts by mass relative to 100 parts by mass of the silane coupling agent. In the case of less than 30 parts by mass, a low refractive index cannot be achieved, and in the case of more than 200 parts by mass, abrasion resistance decreases.

In addition to the above-mentioned essential components, the curable composition for forming the low refractive index layer can be mixed with an appropriate amount of aqueous acid solution such as an aqueous hydrochloric acid solution in order to promote hydrolysis and condensation of the silane coupling agent.

### Hollow Silica Fine Particles

The hollow silica fine particles contained in the low refractive index layer are particles that control the refractive index of the layer. An average particle diameter (D50) is usually 10 nm to 150 nm, preferably 50 nm to 100 nm, and more preferably 50 nm to 70 nm.

The hollow silica fine particles have cavities inside, have a porosity of 20% to 70%, preferably 30% to 50%, and usually have a refractive index of 1.30 or less.

The hollow silica fine particles are commercially available in a state of being dispersed in a solvent, and thus they may be appropriately selected, obtained, and used.

### Formation of Low Refractive Index Layer

The low refractive index layer is formed in the same manner as the formation of the hard coat layer, a curable composition solution (coating liquid) for forming the low refractive index layer is applied onto the antiglare layer and then dried, and is then heated and cured at 70° C. to 120° C. The thickness of the layer is usually set to be in the range of 50 nm to 200 nm from the viewpoint of antireflection properties.

When the antireflection coat is constituted by two layers, that is, a high refractive index layer and a low refractive index layer, the high refractive index layer is first formed on the antiglare layer, and then the low refractive index layer is formed on the high refractive index layer. When the antireflection layer is constituted by three layers, that is, a medium refractive index layer, a high refractive index layer, and a low refractive index layer, the medium refractive index layer is first formed on the antiglare layer, and then the high refractive index layer is formed on the medium refractive index layer, and then the low refractive index layer is formed on the high refractive index layer.

A silane coupling agent, a metal chelate compound, an aqueous acid solution, and an organic solvent to be used for the coating liquid are the same as those described in the section of the hard coat layer. A coating method is also the same as that for the hard coat layer.

### Medium Refractive Index Layer/High Refractive Index Layer

In order to further improve the antireflection properties of the antiglare antireflection plate of the present invention, it is preferable to configure an antireflection coat with a high-order structure that includes a high refractive index layer and a medium refractive index layer.

The medium refractive index layer preferably has a refractive index of 1.50 to 1.75 and a thickness of 50 nm to 200 nm. The high refractive index layer preferably has a refractive index of 1.60 to 2.00 and a thickness of 50 nm to 200 nm. It is essential that the refractive index of the high refractive index layer in the antireflection coating is higher than that of the medium refractive index layer.

The high refractive index layer and the medium refractive index layer are typically formed by curing a curable composition containing 100 to 500 parts by mass of metal oxide particles relative to 100 parts by mass of a silane coupling agent. The amount of metal oxide particles to be mixed is determined appropriately depending on a metal oxide to be used and a refractive index to be set.

The curable compositions for forming the high and medium refractive index layers may be mixed with an appropriate amount of aqueous acid solution, similar to the low refractive index layer.

### Metal Oxide Particles

The metal oxide particles are used for the purpose of setting the refractive indexes of the medium refractive index layer and the high refractive index layer to fall within the above-mentioned predetermined range.

Typically, the metal oxide particles have an average particle diameter of 10 nm to 100 nm and a refractive index of 1.70 or more and 2.80 or less. Specific examples of metal oxide particles to be used include zirconium oxide particles (refractive index=2.40); composite zirconium metal oxide particles in which zirconium oxide and other oxides such as silicon oxide are combined at a molecular level to adjust a refractive index; titanium oxide particles (refractive index=2.71); composite titanium metal oxide particles in which titanium oxide and other oxides such as silicon oxide and zirconium oxide are combined at a molecular level to adjust a refractive index, and the like. These metal oxide particles are selected or appropriately combined to adjust the refractive index of the layer to a desired refractive index. Such particles are known per se and are commercially available in a state of being dispersed in a solvent.

### Organic-Inorganic Composite Compound

An organic-inorganic composite compound may be mixed into the medium and high refractive index layers for the purpose of improving adhesion between the antiglare layer and the low refractive index layer.

The organic-inorganic composite compound is, for example, a composite compound with an alkoxysilyl group bonded thereto, which is obtained by reacting a hydrolyzable alkoxysilane compound with a bisphenol A type epoxy resin having an epoxy equivalent of 180 to 5000. When the composite compound is cured, crosslinking of a terminal epoxy group and higher-order siloxane crosslinking (silica generation) caused by a sol-gel reaction of the alkoxysilyl group occur, resulting in a cured product that has no Tg like glass and have advantages of both organic and inorganic materials.

There are various types of organic-inorganic composite compounds. For example, there are composite compounds having a structure in which an alkoxysilyl group is bonded to a polymer such as a bisphenol A type epoxy resin (hereinafter also referred to as a silane-modified epoxy compound), a novolac phenolic resin, or a polyamic acid compound.

In the present invention, the silane-modified epoxy compound is preferably used as the organic-inorganic composite compound because it has excellent adhesion between the antiglare layer and the refractive index layer and is easily available.

### Formations of Medium and High Refractive Index Layers

The medium and high refractive index layers are formed in the same manner as the formation of the low refractive index layer, and are formed by applying each composition solution (coating liquid) onto the antiglare layer in the order described above, drying it, and then heating and curing it at 70° C. to 120° C.

A silane coupling agent, a metal chelate compound, an aqueous acid solution, and an organic solvent to be used for each curable composition solution are the same as those described in the section of the hard coat layer. A coating method is also the same as that for the hard coat layer.

### Protective Layer

In the present invention, a suitable protective layer is constituted by a cured product obtained by curing a curable composition containing 7.5 to 35 parts by mass of spherical silica fine particles having an average particle diameter of 10 nm or less, relative to 100 parts by mass of a total of 90 to 98 parts by mass of a silane coupling agent and 10 to 2 parts by mass of a metal chelate compound. In addition, it is preferable that the refractive index of the cured product after curing be 1.45 to 1.50, and the thickness of the layer be 10 nm to 15 nm.

The silane coupling agent, the metal chelate compound, and the silica fine particles to be mixed in the curable composition are the same as those used to form the hard coat layer, and can be used without any limitations. The same also applies to a coating method and an organic solvent for forming a coating liquid.

### Anti-Fouling Layer

The anti-fouling layer is a layer, which is provided to exhibit high level of anti-fouling properties, usually having a thickness set to be in a range of 5 nm to 15 nm, and is made of a polymer of a fluorine-containing silicon compound.

Specifically, the polymer of the fluorine-containing silicon compound is a polymer obtained by condensation polymerization of a compound, as a main composition, having a perfluoropolyether structure as a main chain and having an alkoxysilyl group, which is a hydrolyzable group, at one or both ends of the main chain. The presence of the perfluoropolyether structure reduces adhesion of oil and fat, resulting in high anti-fouling properties.

The fluorine-containing silicon compound is commercially available as a solution dissolved in an organic solvent such as isopropyl ether, hexane, or a fluorine-based organic solvent, as products such as “Novec (registered trademark)” manufactured by 3M Company; “Dow Corning (registered trademark)” manufactured by Toray Dow Corning; “SHIN-ETSU SUBELYN (registered trademark)” manufactured by Shin-Etsu Chemical; “Opttool” manufactured by Daikin; and “SURECO (registered trademark)” manufactured by Asahi Glass, and thus it is preferable to obtain and use these.

A solution (coating liquid) containing the fluorine-containing silicon compound is applied onto the protective layer by a usual method, and then kept at a temperature of approximately 100° C. for approximately six to eight hours to be dried and cured into a polymer, thereby forming an anti-fouling layer.

### EXAMPLES

The present invention will be described in detail below with reference to examples, but the present invention is not limited by these examples. In addition, not all combinations of features described in the embodiment are essential for the solution of the present invention.

Various components and abbreviations used in the following examples and comparative example, and measurement methods are as follows.

### [Polymerizable Acrylate Compound]

[Hexafunctional urethane (meth)acrylate]
ac-6: Pentaerythritol triacrylate hexamethylene diisocyanate urethane prepolymer
   [Bifunctional (meth)acrylate compound]
ac-2: Triethylene glycol diacrylate
   [Trifunctional (meth)acrylate compound]
ac-3: Polyester urethane acrylate
ac-4: Pentaerythritol triacrylate

### [Silica Fine Particles]

sp-1: Solid spheres, average particle diameter (D50)=7 nm, refractive index=1.46, IPA dispersion, solid part: 20 wt %
sp-2: Solid spheres, average particle diameter (D50)=40 nm, refractive index=1.46, MEK dispersion, solid part: 30 wt %
sp-3: Hollow particles, average particle diameter (D50)=60 nm, refractive index=1.30, IPA dispersion, solid part: 20 wt %

### [Silica Particles]

sp-4: Solid spheres, average particle diameter (D50)=500 nm, refractive index=1.46, MEK dispersion, solid part: 67 wt %
sp-5: Solid spheres, average particle diameter (D50)=700 nm, refractive index=1.46, MeOH dispersion, solid part: 50 wt %
sp-6: Solid spheres, average particle diameter (D50)=300 nm, refractive index=1.46, MeOH dispersion, solid part: 33 wt %
sp-7: Solid spheres, average particle diameter (D50)=900 nm, refractive index=1.46, MEK dispersion, solid part: 67 wt %

### [Silane Coupling Agent]

γ-GPS: γ-glycidoxypropyltrimethoxysilane

### [Metal Chelate Compound]

ATAA: Aluminum tris(acetylacetonate)

### [Metal Oxide Particles]

z-1: Zirconia particles, average particle diameter=60 nm, refractive index=2.42, PGM (1-methoxy-2-propanol) dispersion, solid part: 53 wt %
z-2: Zirconia particles, average particle diameter=30 nm, refractive index=2.40, BuOH/EtOH dispersion, solid part: 15 wt %

### [Organic-Inorganic Composite Compound]

sep: Silane-modified epoxy compound, DMDG (diethylene glycol dimethyl ether) dispersion

### [Photopolymerization Initiator]

pi-1:1-hydroxy-cyclohexyl-phenyl ketone
pi-2:2-methyl-1-[4-(methylthio)phenyl]-2-morpholinopropan-1-one

### [Ultraviolet Absorber]

UV: Benzotriazole-based ultraviolet absorber

### [Hydrolysis Catalyst]

HCl: 0.05 N hydrochloric acid solution

### [Organic Solvent]

IPA: Isopropyl alcohol
MIBK: Methyl isobutyl ketone
SBAC: Secondary butyl acetate
NPA: Normal propyl alcohol
Eta Cohol: Mixture of ethyl alcohol and isopropyl alcohol

### Average Luminous Reflectance

A reflectance at the lowest point (surface of antiglare antireflection plate) was measured at a scanning speed of 1000 nm/min and in a wavelength range of 380 nm to 780 nm by using an ultraviolet visible light spectrophotometer “V-650” manufactured by Jasco International Co., Ltd. An average luminous reflectance was calculated by multiplying the obtained reflectance by a weighting coefficient specified in JIS-Z-8722. It is indicated that the smaller the value, the better the antireflection properties.

### Average Visual Transmittance

A transmittance at a peak top was measured in the range of 380 nm to 780 nm at a scanning speed of 1000 nm/min by using an ultraviolet visible light spectrophotometer “V-650” manufactured by Jasco International Co., Ltd., and an average visual transmittance was calculated by multiplying the obtained transmittance by a weighting coefficient specified in JIS-Z-8722.

### Various Line Roughness Characteristics

Various line roughness characteristics were measured based on the Japanese Industrial Standard “JIS B 0601” by using a laser microscope “VK-X1000” manufactured by KEYENCE CORPORATION. The values of the line roughness characteristics were automatically calculated using analysis software built into a measuring device. A measured distance was 276 μm, and a total of 26 μm at the beginning and the end was cut off.

### Maximum Peak Height (Rp)/Maximum Valley Depth (Rv)

This is a characteristic value uniquely set in the present invention, and is a value obtained by dividing the maximum peak height (Rp) by the maximum valley depth (Rv) by using a laser microscope “VK-X1000” manufactured by KEYENCE CORPORATION.

### Haze Value

A haze value was measured based on the Japanese Industrial Standard “JIS K 7136” by using a haze meter “HM-150N” manufactured by Murakami Color Research Laboratory. When the haze value is less than 0.5%, glaring will be observed on the surface, and when the haze value is more than 20.0%, white turbidity will occur, inhibiting the plate from functioning as an antiglare antireflection plate.

### Refractive Index

A coating liquid for each refractive index layer was applied onto an acrylic resin base material to a thickness of 100 nm and cured to form each refractive index layer. Next, a refractive index of each layer was calculated from a bottom value of a reflection spectrum by using a spectrophotometer “V-650” manufactured by Jasco International Co., Ltd.

### Example 1

A hard coat layer, an antiglare layer, and an antireflection coating were sequentially formed on a transparent resin base material made of a polymethyl methacrylate resin (PMMA) with a thickness of 1 mm (80 mm length×50 mm width) by using the following method. The thickness of each layer was adjusted by a speed of pulling-up from a dipped coating liquid.

### Coating Liquid for Forming Hard Coat Layer; HC-1

Polymerizable acrylate compound: A mixing ratio per 100 parts by mass of a total amount of the compound is shown in parentheses (the same applies below).
ac-6:126.7 g (85.1 parts by mass)
ac-2:8.0 g (5.4 parts by mass)
ac-3:14.1 g (9.5 parts by mass)

### Silica Fine Particles

sp-1:40.0 g (26.9 parts by mass), dispersion medium IPA 160.0 g

### Silane Coupling Agent

γ-GPS: 12.2 g (8.2 parts by mass)

### Metal Chelate Compound

ATAA; 1.0 g (0.7 parts by mass)

### Ultraviolet Absorber

UV; 11.2 g

### Photopolymerization Initiator

pi-1; 6.4 g
pi-2; 1.6 g

### Hydrolysis Catalyst

HCl; 2.8 g

### Organic Solvent

IPA; 308.0 g
MIBK; 308.0 g

Coating Liquid for Forming Antiglare Layer; AG-1 Polymerizable acrylate compound:
ac-6; 25.2 g (70.0 parts by mass)
ac-4; 10.8 g (30.0 parts by mass)

### Silica Fine Particles

sp-2; 4.0 g (11.1 parts by mass), dispersion medium MEK 9.3 g

### Silica Particles

sp-4; 0.2 g (0.6 parts by mass), dispersion medium MEK 0.1 g

### Metal Chelate Compound

ATAA; 0.2 g (0.6 parts by mass)

### Photopolymerization Initiator

pi-2; 1.4 g (3.9 parts by mass)

### Organic Solvent

IPA; 565.0 g
MIBK; 383.8 g

Coating Liquid for Forming Low Refractive Index Layer; 1-1: A mixing ratio per 100 parts by mass of a silane coupling agent is shown in parentheses.

### Silane Coupling Agent

γ-GPS; 3.6 g (100 parts by mass)

### Silica Fine Particles

sp-3; 1.7 g (46.2 parts by mass), dispersion medium IPA 6.7 g

### Metal Chelate Compound

ATAA; 0.1 g (2.8 parts by mass)

### Hydrolysis Catalyst

HCl; 1.7 g

### Organic Solvent

IPA; 147.7 g
NPA; 49.2 g
SBAC; 49.2 g

First, the transparent resin base material was dip-coated with the coating liquid for forming a hard coat layer having the above composition, dried at 60° C. for five minutes, and then irradiated with ultraviolet light from a mercury lamp for one minute to be UV-cured, thereby forming a hard coat layer having a thickness of 2 μm. Next, the base material having the hard coat layer was dip-coated with the coating liquid for forming an antiglare layer, dried at 60° C. for eight minutes, and then irradiated with ultraviolet light from a mercury lamp for one minute to be UV-cured, thereby forming an antiglare layer having a thickness of 200 nm. Thereafter, the base material having the hard coat layer and the antiglare layer was dip-coated with the coating liquid for forming a low refractive index layer, and then heat-treated at 90° C. for 20 minutes to form an antireflection coating (low refractive index layer) having a thickness of 95 nm and a refractive index of 1.34, thereby obtaining the antiglare antireflection plate of the present invention.

Various physical properties and characteristics of the obtained antiglare antireflection plate were measured and evaluated in accordance with the measurement methods described above. Table 2 shows a layer thickness and optical characteristics of each layer, and Table 3 shows surface characteristics (various line roughness characteristics).

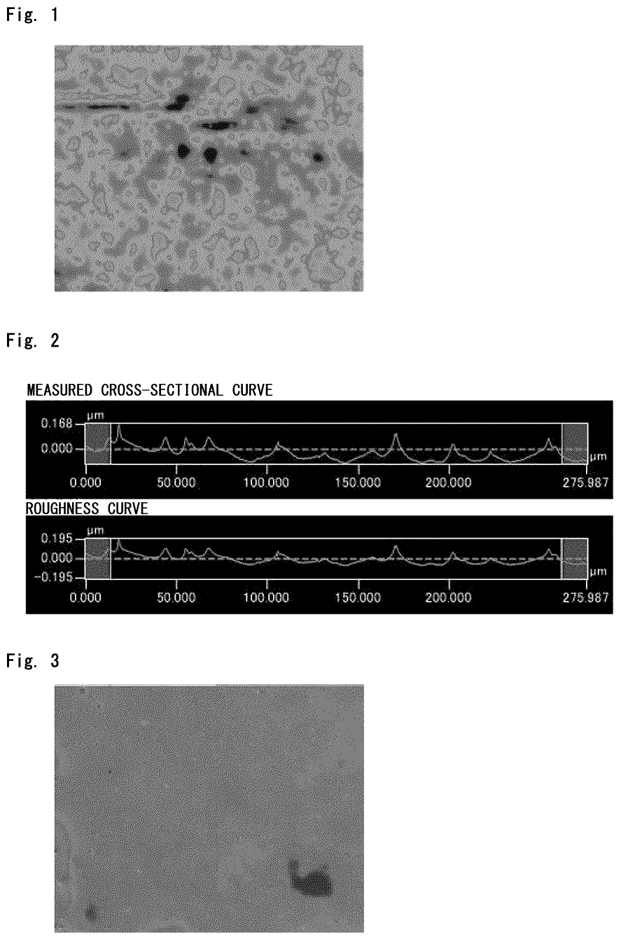

FIG. 1 shows a laser photograph of the obtained plate surface, and FIG. 2 shows a measured cross-sectional curve and a roughness curve. It can be recognized from both the drawings that there are large convex portions.

### Examples 2 and 3

Antiglare antireflection plates were manufactured in the same manner as in Example 1, except that a coating liquid for forming an antiglare layer was changed to a coating liquid having a composition shown in Table 1, and various physical properties and characteristics were measured. The results are shown in Tables 2 and 3.

TABLE 1

| | AG-1 | | AG-2 | | AG-3 | | AG-4 | | AG-7 | |
|---|---|---|---|---|---|---|---|---|---|---|
| | Mixed | Parts | Mixed | Parts | Mixed | Parts | Mixed | Parts | Mixed | Parts |
| | amount g | by mass | amount g | by mass | amount g | by mass | amount g | by mass | amount g | by mass |
| Polymerizable acrylate | | | | | | | | | | |
| ac-6 | 25.2 | 70.0 | 25.2 | 70.0 | 28.0 | 70.0 | 19.6 | 70.0 | 25.2 | 70.0 |
| ac-4 | 10.8 | 30.0 | 10.8 | 30.0 | 12.0 | 30.0 | 8.4 | 30.0 | 10.8 | 30.0 |
| Additive particles | | | | | | | | | | |
| sp-2 | 4.0 | 11.1 | 4.0 | 11.1 | 0.0 | 0.0 | 12.0 | 42.9 | 4.0 | 11.1 |
| Dispersion medium(MEK) | 9.3 | | 9.3 | | 0.0 | | 28.0 | | 9.3 | |
| sp-4 | 0.2 | 0.6 | 5.4 | 15.0 | 0.4 | 1.0 | 0.4 | 1.4 | — | — |
| Dispersion medium(MEK) | 0.1 | | 2.7 | | 0.2 | | 0.2 | | — | — |
| sp- 5 | — | — | — | — | — | — | — | — | 5.4 | 15.0 |
| Dispersion medium(MeOH) | — | — | — | — | — | — | — | — | 5.4 | |
| sp-6 | — | — | — | — | — | — | — | — | — | — |
| Dispersion medium(MeOH) | — | — | — | — | — | — | — | — | — | — |
| sp-7 | — | — | — | — | — | — | — | — | — | — |
| Dispersion medium(MEK) | — | — | — | — | — | — | — | — | — | — |
| Metal chelate compound | 0.2 | 0.6 | 0.2 | 0.6 | 0.2 | 0.5 | 0.2 | 0.7 | 0.2 | 0.6 |
| ATAA | | | | | | | | | | |
| Polymerization initiator pi-2 | 1.4 | 3.9 | 1.4 | 3.9 | 1.6 | 4.0 | 1.1 | 3.9 | 1.4 | 3.9 |
| IPA | 565.0 | | 560.8 | | 574.6 | | 545.3 | | 558.7 | |
| MIBK | 383.8 | | 380.2 | | 383.0 | | 384.8 | | 379.6 | |
| Total mixed amount g | 1000.0 | | 1000.0 | | 1000.0 | | 1000.0 | | 1000.0 | |

### Example 4

An antiglare antireflection plate was manufactured in the same manner as in Example 1, except that an antireflection coat was configured to have a three-layer structure including a medium refractive index layer, a high refractive index layer, and a low refractive index layer, and various physical properties and characteristics were measured. The results are shown in Tables 2 and 3.

Regarding the antireflection coat, a transparent resin base material having a hard coat layer and an antiglare layer formed thereon in order was first dip-coated with the following coating liquid for forming a medium refractive index layer and then heated at 90° C. for 20 minutes to form a medium refractive index layer (layer thickness of 85 nm, refractive index pf 1.64), the medium refractive index layer was dip-coated with the following coating liquid for forming a high refractive index layer and then heated at 90° C. for 20 minutes to form a high refractive index layer (layer thickness of 80 nm, refractive index of 1.77), and then a low refractive index layer was formed in the same manner as in Example 1, thereby forming an antireflection coat (film thickness of 255 nm) having a three-layer structure.

Coating Liquid for Forming Medium Refractive Index Layer; m-1]: A mixing ratio per 100 parts by mass of a silane coupling agent is shown in parentheses.

### Silane Coupling Agent

γ-GPS; 1.5 g (100 parts by mass)

### Organic-Inorganic Composite Compound

sep; 2.4 g (160 parts by mass), dispersion medium DMDG 2.4 g

### Metal Oxide Particles

z-1; 4.8 g (320 parts by mass), dispersion medium PGM 4.3 g

### Metal Chelate Compound

ATAA; 0.1 g (6.7 parts by mass)

### Hydrolysis Catalyst

HCl; 0.9 g

### Organic Solvent

IPA; 97.4 g
SBAC; 146.2 g

Coating Liquid for Forming High Refractive Index Layer; h-1: A mixing ratio per 100 parts by mass of a silane coupling agent is shown in parentheses.

### Silane Coupling Agent

γ-GPS; 1.3 g (100 parts by mass)

### Metal Oxide Particles

z-2; 4.5 g (346 parts by mass), dispersion medium BuOH/EtOH 30.0 g

### Metal Chelate Compound

ATAA; 0.2 g (15.4 parts by mass)

### Hydrolysis Catalyst

HCl; 0.3 g

### Organic Solvent

SBAC; 11.2 g
Eta Cohol; 212.5 g

### Examples 5 to 7

Antiglare antireflection plates were manufactured in the same manner as in Example 4, except that a coating liquid for forming the antiglare layer was changed to a coating liquid having the composition shown in Table 1, and various physical properties and characteristics were measured. The results are shown in Tables 2 and 3.

TABLE 2

| | | Example 1 | Example 2 | Example 3 | Example 4 | Example 5 | Example 6 | Example 7 |
|---|---|---|---|---|---|---|---|---|
| Antireflection | Coating liquid | I-1 | I-1 | I-1 | I-1 | I-1 | I-1 | I-1 |
| coating | Thickness [nm] | 95 | 95 | 95 | 95 | 95 | 95 | 95 |
| | Coating liquid | — | — | — | h-1 | h-1 | h-1 | h-1 |
| | Thickness [nm] | — | — | — | 80 | 80 | 80 | 80 |
| | Coating liquid | — | — | — | m-1 | m-1 | m-1 | m-1 |
| | Thickness [nm] | — | — | — | 85 | 85 | 85 | 85 |
| Antiglare layer | Coating liquid | AG-1 | AG-2 | AG-7 | AG-1 | AG-2 | AG-3 | AG-4 |
| | Thickness [nm] | 200 | 200 | 200 | 200 | 200 | 200 | 200 |
| Hard coat layer | Coating liquid | HC-1 | HC-1 | HC-1 | HC-1 | HC-1 | HC-1 | HC-1 |
| | Thickness [μm] | 2 | 2 | 2 | 2 | 2 | 2 | 2 |

| | | | | | | | |
|---|---|---|---|---|---|---|---|
| Average luminous reflectance[%] | 2.11 | 2.98 | 3.02 | 1.45 | 2.25 | 1.52 | 1.54 |
| Average visual transmittance[%] | 97.7 | 96.9 | 94.9 | 98.4 | 96.4 | 98.1 | 98.2 |
| Haze[%] | 1.7 | 13.2 | 19.6 | 1.2 | 9.4 | 1.4 | 1.6 |

TABLE 3

| | Example 1 | Example 2 | Example 3 | Example 4 | Example 5 | Example 6 | Example 7 |
|---|---|---|---|---|---|---|---|
| Ra[μm] | 0.04 | 0.08 | 0.20 | 0.05 | 0.11 | 0.05 | 0.07 |
| RSm[μm] | 47.21 | 39.83 | 24.25 | 68.39 | 41.87 | 30.61 | 32.34 |
| Rsk | 0.82 | 1.11 | 0.69 | 0.66 | 0.88 | −0.01 | 0.91 |
| Rku | 3.26 | 4.44 | 3.39 | 3.32 | 3.48 | 2.91 | 3.67 |
| Rp[μm] | 0.20 | 0.45 | 0.86 | 0.24 | 0.48 | 0.18 | 0.31 |
| Rv[μm] | 0.07 | 0.21 | 0.65 | 0.14 | 0.24 | 0.15 | 0.15 |
| Rp/Rv | 2.86 | 2.14 | 1.32 | 1.71 | 2.00 | 1.20 | 2.10 |

Note:
Measurement distance: 276 μm,
cutoff: 26 μm

### Comparative Examples 1 to 6

Antiglare antireflection plates were manufactured in the same manner as in Examples 1 and 4, except that a coating liquid for forming an antiglare layer was changed to a coating liquid having the composition shown in Table 4, and various physical properties and characteristics were measured. The results are shown in Tables 5 and 6.

TABLE 4

| | AG-5 | | AG-6 | | AG-8 | | AG-9 | |
|---|---|---|---|---|---|---|---|---|
| | Mixed | Parts | Mixed | Parts | Mixed | Parts | Mixed | Parts |
| | amount g | by mass | amount g | by mass | amount g | by mass | amount g | by mass |
| Polymerizable acrylate | | | | | | | | |
| ac-6 | 25.2 | 70.0 | 25.2 | 70.0 | 25.2 | 70.0 | 25.2 | 70.0 |
| ac-4 | 10.8 | 30.0 | 10.8 | 30.0 | 10.8 | 30.0 | 10.8 | 30.0 |
| Additive particles | | | | | | | | |
| sp-2 | 4.1 | 11.4 | 4.0 | 11.1 | 4.0 | 11.1 | 4.0 | 11.1 |
| Dispersion medium(MEK) | 9.6 | | 9.3 | | 9.3 | | 9.3 | |
| sp-4 | 0.0 | 0.0 | 6.5 | 18.1 | — | — | — | — |
| Dispersion medium(MEK) | 0.0 | | 3.2 | | — | — | — | — |
| sp- 5 | — | | — | — | — | — | — | — |
| Dispersion medium(MeOH) | — | — | — | — | — | — | — | — |
| sp-6 | — | — | — | — | 5.4 | 15.0 | — | — |
| Dispersion medium(MeOH) | — | — | — | — | 11.0 | | — | — |
| sp-7 | — | — | — | — | — | — | 5.4 | 15.0 |
| Dispersion medium(MEK) | — | — | — | — | — | — | 2.7 | |
| Metal chelate compound | 0.2 | 0.6 | 0.2 | 0.6 | 0.2 | 0.6 | 0.2 | 0.6 |
| ATAA | | | | | | | | |
| Polymerization initiator pi-2 | 1.4 | 3.9 | 1.4 | 3.9 | 1.4 | 3.9 | 1.4 | 3.9 |
| IPA | 565.0 | | 563.3 | | 555.9 | | 560.8 | |
| MIBK | 383.7 | | 376.1 | | 376.8 | | 380.2 | |
| Total mixed amount g | 1000.0 | | 1000.0 | | 1000.0 | | 1000.0 | |

TABLE 5

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Antireflection | Coating liquid | I-1 | I-1 | I-1 | I-1 | I-1 | I-1 |
| coating | Thickness [nm] | 95 | 95 | 95 | 95 | 95 | 95 |
| | Coating liquid | — | — | — | — | h-1 | h-1 |
| | Thickness [nm] | — | — | — | — | 80 | 80 |
| | Coating liquid | — | — | — | — | m-1 | m-1 |
| | Thickness [nm] | — | — | — | — | 85 | 85 |
| Antiglare layer | Coating liquid | AG-5 | AG-6 | AG-8 | AG-9 | AG-5 | AG-6 |
| | Thickness [nm] | 200 | 200 | 200 | 200 | 200 | 200 |
| Hard coat layer | Coating liquid | HC-1 | HC-1 | HC-1 | HC-1 | HC-1 | HC-1 |
| | Thickness [μm] | 2 | 2 | 2 | 2 | 2 | 2 |

| | | | | | | |
|---|---|---|---|---|---|---|
| Average luminous reflectance[%] | 1.98 | 3.32 | 2.92 | — | 1.22 | — |
| Average visual transmittance[%] | 97.8 | 95.2 | 96.9 | — | 98.7 | — |
| Haze[%] | 0.3 | 22.1 | 0.4 | 36.9 | 0.4 | 17.6 |

TABLE 6

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Ra[μm] | 0.08 | White | 0.05 | White | 0.44 | White |
| RSm[μm] | 90.18 | turbidity | 17.06 | turbidity | 132.3 | turbidity |
| Rsk | −0.81 | Not | 0.00 | Not | 3.48 | Not |
| Rku | 3.06 | measured | 2.84 | measured | 20.46 | measured |
| Rp[μm] | 0.21 | | 0.20 | | 5.11 | |
| Rv[μm] | 0.26 | | 0.20 | | 0.74 | |
| Rp/Rv | 0.80 | | 1.00 | | 6.91 | |

Note:
Measurement distance: 276 μm,
cutoff: 26 μm

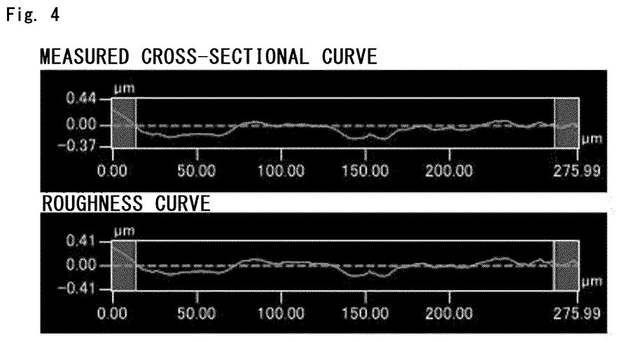

Comparative Example 1 is an example in which inorganic particles with a large average particle diameter are not contained. In Comparative Example 1, a haze value was small and surface glaring was clearly observed. FIG. 3 shows a laser photograph of the surface of the obtained plate in this Comparative Example 1, and FIG. 4 shows a measured cross-sectional curve and a roughness curve. It can be understood from both the drawings that there are no large convex portions.

Comparative Example 2 is an example in which a large amount of inorganic particles with a large average particle diameter are contained. In Comparative Example 2, a haze value was large and white turbidity occurred, and thus the antiglare antireflection plate had no product value. Thus, line roughness characteristics were not measured.

Comparative Example 3 shows a case where an average particle diameter of inorganic particles is excessively small. In Comparative Example 3, a haze value was small and surface glaring was clearly observed.

Comparative Example 4 is an example in which an average particle diameter of inorganic particles is excessively large. In Comparative Example 4, a haze value was large and white turbidity occurred, and thus the antiglare antireflection plate had no product value. Thus, line roughness characteristics were not measured.

Comparative Example 5 is an example in which the antireflection coat has a three-layer structure and does not contain inorganic particles with a large average particle diameter. In Comparative Example 5, a haze value was small and surface glaring was clearly observed.

Comparative Example 6 is an example in which the antireflection coat has a three-layer structure and contains a large amount of inorganic particles with a large average particle diameter. In Comparative Example 6, a haze value was large and white turbidity occurred, and thus the antiglare antireflection plate had no product value. Thus, line roughness characteristics were not measured.

What is claimed is:

1. An antiglare antireflection plate comprising:
a hard coat layer;
an antiglare layer; and
an antireflection coat,
the hard coat layer, the antiglare layer, and the antireflection coat being laminated in this order on a transparent resin base material,
wherein the antiglare layer is made of a cured product of a composition containing 0.1 to 15.0 parts by mass of inorganic particles having an average particle diameter (D50) of 500 nm to 700 nm relative to 100 parts by mass of a polymerizable acrylate compound, and
line roughness characteristics defined in JIS B 0601 on a surface of the antiglare antireflection plate are as follows:
an arithmetic average roughness (Ra) of 0.03 μm or more and 0.20 μm or less,
an average length (RSm) of 10 μm or more and 70 μm or less,
a skewness (Rsk) of −0.05 or more and 1.50 or less,
a kurtosis (Rku) of 2.0 or more and 5.0 or less, and
a maximum peak height (Rp)/maximum valley depth (Rv) of 1.0 or more and 3.0 or less.

2. The antiglare antireflection plate of claim 1, wherein the antireflection coat is constituted by a low refractive index layer having a refractive index of 1.20 to 1.45 and a layer thickness of 50 nm to 200 nm, the inorganic particles are silica particles, and the antiglare antireflection plate has a haze value of 0.5% to 20.0%.

3. The antiglare antireflection plate of claim 1, wherein the antireflection coat includes a medium refractive index layer having a refractive index of 1.50 to 1.75 and a layer thickness of 50 nm to 200 nm, a high refractive index layer having a refractive index of 1.60 to 2.00 and a layer thickness of 50 nm to 200 nm, and a low refractive index layer having a refractive index of 1.20 to 1.45 and a layer thickness of 50 nm to 200 nm in this order, the refractive index of the high refractive index layer is higher than the refractive index of the medium refractive index layer, the inorganic particles are silica particles, and the antiglare antireflection plate has a haze value of 0.5% to 15.0%.

4. The antiglare antireflection plate of claim 1, wherein the antiglare layer is made of a cured product having a composition containing 0.1 to 15.0 parts by mass of inorganic particles, 0.1 to 1.0 parts by mass of a metal chelate compound, and 0.0 to 45.0 parts by mass of silica fine particles, relative to 100 parts by mass of a polymerizable acrylate compound (total 100% by mass) containing 70% to 90% by mass of a hexafunctional urethane (meth)acrylate compound and 30% to 10% by mass of a bi- to tetrafunctional (meth)acrylate compound.

5. The antiglare antireflection plate of claim 1, wherein an average layer thickness of the antiglare layer is 100 nm to 500 nm.

6. The antiglare antireflection plate of claim 1, wherein a protective layer and an anti-fouling layer are further laminated in this order above the antireflection coat (on a viewing side).
